(19) United States
(12) Patent Application Publication
(10) Pub. No.: US 2026/0201154 A1
(43) Pub. Date: Jul. 16, 2026

(54) PROCESS FOR PRODUCING A BLENDED LOW DENSITY POLYETHYLENE COMPOSITION COMPRISING RECYCLED POLYMER COMPOSITIONS

(71) Applicant: Basell Polyolefine GmbH, Wesseling (DE)

(72) Inventors: Timo Hees, Frankfurt/M (DE); Andreas Maus, Frankfurt/M (DE); Gerhardus Meier, Frankfurt/M (DE); Yannick Ederle, Frankfurt/M (DE)

(73) Assignee: Basell Polyolefine GmbH, Wesseling (DE)

(21) Appl. No.: 19/139,255

(22) PCT Filed: Dec. 18, 2023
(86) PCT No.: PCT/EP2023/086366

§ 371 Date: Jun. 13, 2025

(30) Foreign Application Priority Data
Dec. 19, 2022 (EP) 22214672.2

(51) Int. Cl. C08L 23/06

(52) U.S. Cl. CPC C08L 23/06; C08L 2203/14; C08L 2203/16; C08L 2205/02; C08L 2205/03; C08L 2207/066; C08L 2207/20

(57) ABSTRACT

A process for producing a blended low density polyethylene composition including the step of: blending a first component made from or containing one or more recycled polymer compositions and a second component made from or containing one or more low density polyethylenes.

### FIELD OF THE DISCLOSURE

In general, the present disclosure relates to the field of chemistry. More specifically, the present disclosure relates to polymer chemistry. In particular, the present disclosure relates to a process for producing a blended low density polyethylene (LDPE) composition made from or containing one or more recycled polymer compositions.

### BACKGROUND OF THE DISCLOSURE

Low density polyethylene is a thermoplastic polymer with a variety of uses. Some of the various applications include films for packaging, agricultural films, shopping bags, heavy-duty shipping sacks, foamed articles, caps and closures, tubing, pipes, automotive parts, housewares, medical applications, liners and toys.

In some instances, the various applications have different specifications for the polymer.

In some instances, foamed articles and blown films specify a balance of molecular weight and melt strength. In some instances, molecular weight is specified in terms of melt flow index.

In some instances and to reduce the environmental footprint of polymer materials, there is an ongoing drive to re-use materials as well as reduce the quantity of “new” materials used in the production of a variety of articles.

Regarding polymer materials, there is a drive to recycle materials and reduce the quantity of “virgin” polymer material used in the production of a variety of articles. As used herein, the term “virgin polymer material” refers to polymer material that is provided as new polymers obtained from polymerization processes. In some instances, the polymerization processes use fossil materials-based monomeric materials, biologically derived monomers, or both.

In some instances, LDPE recyclate comes from recovery of post-consumer waste, industrial plastic waste, or both.

In some instances, LDPE recyclate materials are obtained by separation from waste streams. In some instances, LDPE recyclate materials contain other polyethylene components, have variable properties, and undergo further processing. In some instances, the further processing includes treatment with radical initiators, thereby rendering the LDPE recyclate useful for various applications. In some instances, the other polyethylene components include linear low density polyethylene (LLDPE).

### SUMMARY OF THE DISCLOSURE

In a general embodiment, the present disclosure provides a process for producing a blended low density polyethylene composition, including the step of:
blending
   from 30 to 90% by weight of a first component made from or containing one or more recycled polymer compositions, based upon the total weight of the low density polyethylene composition, and
   from 70 to 10% by weight of a second component made from or containing one or more low density polyethylenes, based upon the total weight of the low density polyethylene composition,
wherein the blended low density polyethylene composition has
   a) a density from 0.910 to 0.940 g/cm³, determined according to ISO 1183-1:2012 at 23° C.;
   b) a ratio MIP/MIE from 1.8 to 6, where MIP is the melt flow index at 190° C. with a load of 5 kg; and MIE is the melt flow index at 190° C. with a load of 2.16 kg, both determined according to ISO 1133-2:2011;
   c) MIP values from 3 to 20 g/10 min;
   d) ER values from 1 to 4; and
   e) a ratio MIE/ER from 0.2 to 2.8;
wherein ER is calculated from

$$ER = ( 1.781 * {10}^{- 3} ) * G ’$$

$$at a value of G ” = 0.5 kPa ( 5000 dyn / {cm}^{2} ) ;$$

$$wherein :$$

$$G ’ = storage modulus$$

$$G ” = loss modulus ;$$

both G′ and G″ being measured with dynamic oscillatory shear in a plate-plate rotational rheometer at a temperature of 190° C.
In some embodiments, the blended low density polyethylene composition is made from or containing from 30 to 90% by weight, alternatively from 35 to 80% by weight, alternatively from 40 to 70% by weight, of the first component, based upon the total weight of the low density polyethylene composition, and from 70 to 10% by weight, alternatively from 65 to 20% by weight, alternatively from 60 to 30% by weight, of the second component, based upon the total weight of the low density polyethylene composition. In some embodiments, the blended low density polyethylene composition has a density from 0.915 to 0.935 g/cm³. In some embodiments, the blended low density polyethylene composition has a ratio MIP/MIE from 2 to 5. In some embodiments, the blended low density polyethylene composition has MIP values from 4 to 15 g/10 min. In some embodiments, the blended low density polyethylene composition has ER values from 1.2 to 4, alternatively from 1.2 to 3.5. In some embodiments, the blended low density polyethylene composition has a ratio MIE/ER from 0.3 to 2.5.

In some embodiments, the blended low density polyethylene composition is useful in foamed articles, blown films, or both.

In some embodiments, the MIP/MIE ratio of the low density polyethylene is from 1.80 to 6.00, alternatively from 2.00 to 5.00. In some embodiments, the MIP values are from 3.00 g/10 min to 20.00 g/10 min, alternatively from 4.00 g/10 min to 15.00 g/10 min. In some embodiments, the ER values range from 1.00 to 4.00, alternatively from 1.20 to 4.00, alternatively from 1.20 to 3.50. In some embodiments, the ratio MIE/ER is from 0.20 to 2.80, alternatively from 0.30 to 2.50.

In some embodiments, at least one of the following additional features applies:
the ratio of MIP/MIE of the first component and MIP/MIE of the blended low density polyethylene composition (MIP/MIE_{first component}:MIP/MIE_{blended LDPE composition}) is from 0.50 to 1.80, alternatively from 0.60 to 1.30, alternatively from 0.85 to 1.10;
the MIP ratio of the blended low density polyethylene composition and the first component (MIP_{blended LDPE composition}:MIP_{first component}) is from 1.5 to 15, alternatively from 1.50 to 15.00, alternatively from 1.8 to 10, alternatively from 1.80 to 10.00; or
the ER ratio of the first component and the blended low density polyethylene composition (ER_{first component}:ER_{blended LDPE composition}) is from 0.8 to 3, alternatively from 0.80 to 3.00, alternatively from 1.0 to 2.5, alternatively from 1.00 to 2.50, alternatively from 1.0 to 1.7, alternatively from 1.00 to 1.70.

In some embodiments, at least one of the following additional features applies:
the ratio of MIP/MIE of the first component and MIP/MIE of the second component (MIP/MIE_{first component}:MIP/MIE_{second component}) is from 0.50 to 2.00, alternatively from 0.60 to 1.80, alternatively from 0.70 to 1.4;
the MIP ratio of the second component and the first component (MIP_{second component}:MIP_{first component}) is from 2 to 100, alternatively from 2.00 to 100.00, alternatively from 4 to 80, alternatively from 4.00 to 80.00; or
the ER ratio of the first component and the second component (ER_{first component}:ER_{second component}) is from 1.5 to 10, alternatively from 1.50 to 10.00, alternatively from 1.9 to 9, alternatively 1.90 to 9.00.

In some embodiments, the blended low density polyethylene composition is made from or containing from 20 to 95% by weight, alternatively from 30 to 90% by weight, alternatively from 35 to 80% by weight, alternatively from 40 to 70% by weight, of the recyclate fraction, based upon the total weight of the blended low density polyethylene composition.

In some embodiments, the first and second components are melt blended in an extruder device at a temperature of from 180 to 250° C., alternatively from 190 to 240° C.

In some embodiments, the first component is made from or containing recyclate, having a density of from 0.910 to 0.940 g/cm³.

In some embodiments, the process further includes the step of: homogenizing the first component and the second component. In some embodiments, the homogenizing step is performed before melt blending the components or during melt blending of the components.

In some embodiments, the homogenizing step is performed before melt blending and a mixing device is provided for mixing the first and second components, thereby forming a homogenous precursor that is subsequently introduced into the extruder device. In some embodiments, the mixing device is a tumble mixer.

In some embodiments, the first and second components are mixed and blended together without being subjected to a vis-breaking process. In some embodiments, neither the first component nor second component was prepared by vis-breaking.

In some embodiments, the extruder device has at least two screws arranged parallel to each other and operated in a co-rotating manner.

In some embodiments, the second component is made from or containing virgin LDPE.

In some embodiments, the first component is further made from or containing one or more additional polyethylene components selected from the group consisting of HDPE, MDPE, LLDPE and mixtures thereof.

In some embodiments, the blended low density polyethylene composition is made from or containing from 1 to 40% by weight, alternatively from 5 to 35% by weight, alternatively from 8 to 30% by weight, alternatively from 10 to 25% by weight, of LLDPE, based upon the total weight of the low density polyethylene composition.

In some embodiments, the blended low density polyethylene composition has at least one of the following additional features:
a MIE of 1 g/10 min or higher, alternatively from 1 to 10, alternatively from 1 to 8 g/10 min;
a Mw from 60000 to 180000 g/mol;
a Mw/Mn ratio from 3 to 18, alternatively from 4 to 13; or
F(max) values of 0.04 N or higher, alternatively from 0.04 to 2 N, alternatively from 0.05 to 0.2 N, measured with a Rheotens device at 190° C. with an acceleration of 2.4 mm/s².

In some embodiments, the present disclosure provides a blended low density polyethylene composition. In some embodiments, the blended low density polyethylene composition is produced by the process.

In some embodiments, the present disclosure provides a manufactured article made from or containing the blended low density polyethylene composition.

In some embodiments, the manufactured article is in the form of a foamed article, a cast film, or a blown film.

### DETAILED DESCRIPTION OF THE DISCLOSURE

As used herein, the term “low density polyethylene” refers to, as alternatives, both a single ethylene polymer and a polyethylene composition, that is, a composition made from or containing two or more ethylene polymers.

As used herein, the term “virgin” polymer refers to a polymer, which is yet to be processed for production of finished articles, like fibers or sheets for thermoforming. In some embodiments, the virgin polymer is obtained from polymerization processes. In some embodiments, the polymerization processes use fossil materials-based monomeric materials, biologically derived monomeric materials, or both. Biobased polyethylenes and monomers are derived from natural products and are distinguished from polymers and monomers obtained from fossil-fuel sources. In some embodiments, biobased materials are obtained from sources that actively reduce CO₂ in the atmosphere or otherwise emit less CO₂ during production. In some instances, these materials are regarded as “green” or renewable.

In some embodiments, the virgin polymer has not been subjected to post-processing. In some embodiments, pelletization is considered part of the polymer production process and not post-processing. As such and in some embodiments, the virgin polymer has undergone pelletization.

In some embodiments, the second component is made from or containing virgin LDPE, alternatively virgin LDPE obtained from fossil materials based monomeric materials.

As used herein, the term “recyclate” refers to post-consumer recycled (“PCR”) polymer, post-industrial recycled (“PIR”) polymer, or both. In some embodiments, PCR polymer is recyclate derived from an end product that has completed the product's life cycle as a consumer item and would otherwise be disposed of as waste (for example, a polyethylene water bottle). In some embodiments, PIR polymer recyclate is derived from plastic scrap that is generated as waste from an industrial process. In some embodiments, PCR polyolefins include polyolefins that have been collected in commercial and residential recycling programs, including flexible packaging (cast film, blown film and BOPP film), rigid packaging, blow molded bottles, and injection molded containers.

As used herein, the term “about” refers to the stated value plus or minus the margin of error of measurement or plus or minus 10% if no method of measurement is indicated.

As used herein, the term “comprising” refers to “including”, “encompassing”, or “containing”. As used herein, the term “comprising” includes the explicitly recited elements and allows for the presence of other non-recited elements. In some embodiments and as used herein, the term “comprising” may have the limited meaning of “consisting of” or “consists of”. “Consisting of” certain features refers to merely consisting of the features, whether explicitly stated or not. In some embodiments, the term “consisting of” has the meaning “consisting essentially of”.

As used herein, the terms “comprise”, “have”, “include” and “contain” (and variants) are open-ended linking verbs and allow for the addition of other elements.

As used herein, the terms “consisting of” or “consist of” are closed and exclude additional elements.

As used herein, the term “consisting essentially of” excludes additional material elements while allowing for the inclusion of non-material elements that do not change the nature of the disclosed embodiment.

In some embodiments, the recyclate is a material deriving from an article manufacturing process. In some embodiments and as used herein, the term “recyclate” encompasses “regrind” material.

In some embodiments, through a step of separation from other polymers, such as PVC, PET or PS, two main polyolefinic fractions are obtained: (1) polyethylene recyclate and (2) polypropylene recyclate. In some embodiments, the polyethylene recyclate is made from or containing a polyethylene selected from the group consisting of HDPE, MDPE, LDPE, and LLDPE. In some embodiments, the polypropylene recyclate is made from or containing a polypropylene selected from the group consisting of homopolymers, random copolymers and heterophasic copolymers. In some embodiments, polyethylene recyclate is further separated to recover a portion containing LDPE, in amounts of 35% by weight or more, with respect to the total weight.

In some embodiments, the first component is made from or containing recyclate material, alternatively recyclate material having a LDPE as a large fraction, that is, recyclate LDPE. In some embodiments, the LDPE fraction of the recycle material is larger than 25% by weight, alternatively larger than 30% by weight, alternatively larger than 45% by weight, with respect to the total weight of the first component.

In some embodiments, the first component has a density of between 0.910 to 0.940 g/cm³. In some embodiments, the first component has a ratio MIP/MIE of 2 to 5, an ER of 2 to 6, or both.

In some embodiments, at least one of the following additional features applies:
the MIP/MIE ratio of the first component and the second component is from 0.50 to 2.00, alternatively from 0.60 to 1.80, alternatively from 0.70 to 1.4;
the MIP ratio of the second component and the first component is from 2 to 100, alternatively from 4 to 80; or
the ER ratio of the first component and the second component is from 1.5 to 10, alternatively from 1.9 to 9.

As used herein, the term “LDPE” refers to ethylene homopolymers and ethylene copolymers produced in radical polymerization.

In some embodiments, the polymerization is carried out under high pressure.

In some embodiments, LDPE copolymers are selected from the group consisting of ethylene-vinyl acetate copolymers, ethylene-vinyl alcohol copolymers, ethylene-acrylate copolymers, ethylene-methacrylate copolymers, ethylene-α-olefin copolymers and mixtures thereof.

In some embodiments, a-olefin comonomers in the LDPE copolymers are C₃-C₁₀ a-olefins. In some embodiments, the C₃-C₁₀ a-olefins are selected from the group consisting of propylene, 1-butene, 1-hexene, 1-octene and mixtures thereof.

In some embodiments, comonomers are present in amounts up to 15% by weight, alternatively up to 10% by weight, alternatively up to 5% by weight, with respect to the total weight of the copolymer. In some embodiments, the comonomers are present in amounts ranging from 0.001 to 15% by weight, based on the total weight of the copolymer.

As used herein, the term “copolymer” also includes polymers containing more than one kind of comonomers, such as terpolymers.

There are two basic high pressure polymerization processes for the manufacture of LDPE: autoclave and tubular.

In some embodiments, the autoclave reactor process produces LDPE (“autoclave LDPE”), having a concentration of long chain branches, elongational hardening, and a broad molecular weight distribution, rendering autoclave LDPE easy to process.

In some embodiments, the autoclave polymerization is carried out in the presence of radical initiating agents selected from organic peroxides.

In some embodiments, the tubular reactor process is conducted in the absence of organic peroxides. In some embodiments, the tubular reactor process is carried out by using oxygen alone as the radical initiating agent, thereby preparing LDPE which is free from products of chemical degradation of organic peroxides.

In some embodiments, the LDPE is prepared with a mixed process, combining both autoclave and tubular reactors.

In some embodiments, the process operating conditions include various pressure and temperature parameters. In some embodiments, the process operating conditions include a pressure in the range of from 70 MPa to 700 MPa, alternatively from 140 to 190 MPa. In some embodiments, the process operating conditions include a temperature in the range of from 150° C. to 500° C., alternatively from 150° C. to 320° C.

In some embodiments, the polymerization gas is made from or containing one or more chain transfer agents. In some embodiments, the chain transfer agents are selected from the group consisting of propylene, propane and propionic aldehyde.

In some embodiments, the chain transfer agents regulate the molecular weights.

In some embodiments, the LDPE is prepared as described in U.S. Pat. No. 3,691,145 and United States Patent Application No. 2010/0076160, in a tubular reactor process.

In some embodiments, virgin LDPE polymers are commercially available with the brand names Lupolen (from LyondellBasell) and Petrothene (from Equistar).

In some embodiments, recyclate compositions are polyethylene compositions commercially available with the brand name Nextfilm (from Suez).

In some embodiments, the first component, alternatively the LDPE recyclate, and consequently the blended low density polyethylene composition are made from or containing one or more additional polyethylene components. In some embodiments, the additional polyethylene components are selected from the group consisting of from HDPE, MDPE, LLDPE, and mixtures thereof. In some embodiments, HDPE (High Density Polyethylene) has a density from 0.940 to 0.965 g/cm³. In some embodiments, MDPE (Medium Density Polyethylene) has a density from 0.926 to 0.940 g/cm³. In some embodiments, LLDPE (Linear Low Density Polyethylene) has a density from 0.910 to 0.925 g/cm³.

In some embodiments, these additional components are obtained by polymerization processes in the presence of coordination catalysts.

In some embodiments, the blended low density polyethylene composition is made from or containing more than two components. In some embodiments, a third component is added. In some embodiments, the third component is selected from the group consisting of HDPE, MDPE, LLDPE and mixtures thereof.

In some embodiments, the polymerization process is carried out in the presence of a Ziegler-Natta catalyst or single site catalyst.

In some embodiments, the Ziegler-Natta catalyst is made from or containing the product of the reaction of an organometallic compound of group 1, 2 or 13 of the Periodic Table of Elements with a transition metal compound of groups 4 to 10 of the Periodic Table of Elements (new notation). In some embodiments, the transition metal compound is selected from the group consisting of compounds of Ti, V, Zr, Cr and Hf. In some embodiments, the transition metal compound is supported on MgCl₂.

In some embodiments, the organometallic compounds are organo-Al compounds.

In some embodiments, the single site catalysts are selected from metallocene and non-metallocene single site catalysts.

In some embodiments, the metallocene single site catalysts are selected from the group consisting of zirconocenes and hafnocenes. In some embodiments, the metallocene single site catalysts are cyclopentadienyl or indenyl complexes of zirconium or hafnium. In some embodiments, the metallocene single site catalysts are bis(cyclopentadienyl) zirconium dichloride, bis(indenyl) zirconium dichloride or bis(indenyl) hafnium dichloride.

In some embodiments, the non-metallocene single site catalysts are iron complex compounds. In some embodiments, the non-metallocene single site catalysts are iron complex compounds having a tridentate ligand.

In some embodiments, the blended low density polyethylene composition is prepared by processing the components in an extruder device. In some embodiments, the extruder devices are extruders or continuous mixers. In some embodiments, the extruders or mixers are single- or two-stage machines, which melt and homogenize the low density polyethylene composition. In some embodiments, the extruders are pin-type extruders, planetary extruders or corotating disk processors. In some embodiments, the apparatuses are combinations of mixers with discharge screws, gear pumps, or both. In some embodiments, the extruders are screw extruders, alternatively multi-screw extruders, alternatively twin-screw extruders. In some embodiments, the apparatuses are selected from the group consisting of twin-screw extruders and continuous mixers with discharge elements. In some embodiments, the apparatuses are selected from the group consisting of continuous mixers with counter rotating twin rotor and extruder devices including at least one co-rotating twin screw extruder. In some embodiments, the components are homogenized in a mixing device. In some embodiments, the components are homogenized before being fed to the extruder device. In some embodiments, the mixing device is a tumble mixer. In some embodiments, the apparatuses are commercially available from Leistritz Extrusionstechnik GmbH, Nuremberg, Germany; Coperion GmbH, Stuttgart, Germany; KraussMaffei Berstorff GmbH, Hannover, Germany; The Japan Steel Works LTD., Tokyo, Japan; Farrel Corporation, Ansonia, USA; or Kobe Steel, Ltd., Kobe, Japan. In some embodiments, extruder devices are further equipped with units for pelletizing the melt, such as underwater pelletizers.

In some embodiments, more than two components are provided that form the blended low density polyethylene composition. In some embodiments, the components are added in subsequent extrusion steps or together with the first and second component.

As used herein and in an extruder device, the term “specific energy input (SEI)” refers to the energy input that is mechanically applied to the melt through the rotation of the screws and which correlates to the power consumption of the motor. In some embodiments, SEI is expressed in kWh/kg.

In some embodiments, the SEI value ranges from 0.05 to 0.20 kWh/kg, alternatively from 0.08 to 0.15 kWh/kg.

In some embodiments, the temperatures at which the blending step is carried out are low enough to avoid thermal vis-breaking, alternatively equal to or lower than 250° C., alternatively lower than 240° C.

In some embodiments, the lower limit of the temperature at which the blending step is carried out is equal to or higher than the melting point of the polymer material employed in such step. In some embodiments, the lower limit is 180°, alternatively 190° C.

In some embodiments, the blended low density polyethylene composition is further made from or containing additives. In some embodiments additives are fed before, during or after melt blending.

In some embodiments, additives are the types of additives for preparing polyethylene compositions. In some embodiments, the additives are selected from the group consisting of antioxidants, melt stabilizers, light stabilizers, acid scavengers, lubricants, processing aids, antiblocking agents, slip agents, antistatic agents, antifogging agents, pigments or dyes, nucleating agents, flame retardants, and fillers. In some embodiments, several additives are added. In some embodiments, the multiple additives are different types of additives. In some embodiments, more than one representative of a type of additives are added to the low density polyethylene. In some embodiments, the additives are commercially available. In some embodiments, the additives are as described in Hans Zweifel, Plastics Additives Handbook, 5^{th} Edition, Munich, 2001.

In some embodiments, the low density polyethylene product is used in applications having a melt strength specification. In some embodiments, the application is for foamed articles or blown films. In some embodiments, the foamed articles are used for flexible packaging. In some embodiments, the low density polyethylene composition has F(max) values of 0.03 N or higher, alternatively 0.04 to 2 N, alternatively from 0.05 to 0.2 N, measured with a Rheotens device at 190° C. with an acceleration of 2.4 mm/s².

In some embodiments, independently or in combination with the F(max) values, the low density polyethylene product has at least one of the following additional features:
a Mw from 60000 to 180000 g/mol; or
a Mw/Mn ratio from 3 to 18, alternatively from 4 to 13.

In some embodiments, the foamed articles are produced via a chemical blowing process or via a physical blowing process. In some embodiments, physically blown polyolefin foam is produced with blowing agents such as isobutane, pentane and cyclopentane. In some embodiments, physically blown polyolefin foams yield higher expansion than comparable chemically blown polyolefin foams, thereby lower density of physically blown polyolefin foams as compared to chemically blown polyolefin foams. In some embodiments, the foams are either uncrosslinked or crosslinked.

In some embodiments, foams, made from or containing the present low density polyethylene, have a density in the range of from 12 kg/m³ to 60 kg/m³. In some embodiments, the foams are used in protective packaging for electronics, furniture, fruits, glass items, toys, among other things, or with other articles for cushioning protection from shock, vibration, or both. In some embodiments, the foams are used in protective packaging for articles for insulation from heat.

In some embodiments, the technique of blown film or tubular film extrusion is used to prepare plastic films. The process involves extrusion of a molten thermoplastic resin through an annular die, followed by “bubble-like” expansion of the molten web.

### EXAMPLES

In some instances, the practice of the various embodiments, compositions and methods as provided herein are disclosed below in the following examples. These Examples are illustrative and not intended to limit the scope of the appended claims in any manner whatsoever.

The following analytical methods were used to characterize the polymer compositions.

### Melt Flow Index

Determined according to ISO 1133-1 2012-03 at 190° C. with the specified load.

### Density

Determined according to ISO 1183-1:2012 at 23° C.

### Molecular Weight Distribution Determination

The determination of the means Mw and Mn and of Mw/Mn derived therefrom was carried out by high-temperature gel permeation chromatography, using a method described in ISO 16014-1, -2, -4, issues of 2003. The solvent was 1,2,4-trichlorobenzene (TCB) The temperature of apparatus and solutions was 135° C. A PolymerChar (Valencia, Paterna 46980, Spain) IR-4 infrared detector, capable for use with TCB, was the concentration detector. A WATERS Alliance 2000, equipped with pre-column SHODEX UT-G and separation columns SHODEX UT 806 M (3×) and SHODEX UT 807 (Showa Denko Europe GmbH, Konrad-Zuse-Platz 4, 81829 Muenchen, Germany) connected in series, was used.

The solvent was vacuum distilled under nitrogen and stabilized with 0.025% by weight of 2,6-di-tert-butyl-4-methylphenol. The flowrate used was 1 ml/min. The injection was 500 μl. The polymer concentration was in the range of 0.01%<conc.<0.05% w/w. The molecular weight calibration was established by using monodisperse polystyrene (PS) standards from Polymer Laboratories (now, Agilent Technologies, Herrenberger Str. 130, 71034 Boeblingen, Germany) in the range from 580 g/mol up to 11600000 g/mol and additionally with hexadecane.

The calibration curve was then adapted to polyethylene (PE) by the Universal Calibration method (Benoit H., Rempp P. and Grubisic Z., & in J. Polymer Sci., Phys. Ed., 5, 753(1967)). The Mark-Houwing parameters used were for PS: k_{PS}=0.000121 dl/g, α_{PS}=0.706 and for PE k_{PE}=0.000406 dl/g, α_{PE}=0.725, valid in TCB at 135° C. Data recording, calibration and calculation were carried out using NTGPC_Control_V6.02.03 and NTGPC_V6.4.24 (hs GmbH, HauptstraBe 36, D-55437 Ober-Hilbersheim, Germany) respectively.

### Complex Shear Viscosity η_{0.02} (eta (0.02)) and ER

Measured at angular frequency of 0.02 rad/s and 190° C. as follows.

Samples were melt-pressed for 4 min under 200° C. and 200 bar into plates of 1 mm thickness. Disc specimens of a diameter of 25 mm were stamped and inserted in the rheometer, which was pre-heated at 190° C. The measurement was performed using the Anton Paar MCR 300, with a plate-plate geometry. A frequency-sweep was performed (after 4 min of annealing the sample at the measurement temperature) at T=190° C., under constant strain-amplitude of 5%, measuring and analyzing the stress response of the material in the range of excitation frequencies ω from 628 to 0.02 rad/s. The standardized basic software was utilized to calculate the rheological properties, that is, the storage-modulus, G′, the loss-modulus, G″, the phase lag δ (=arctan(G″/G′)) and the complex viscosity, η*, as a function of the applied frequency, namely η* (ω)=[G′ (ω)2+G″ (ω)2]^{1/2}/ω. The value of the latter at an applied frequency ω of 0.02 rad/s was the η_{0.02}.

ER was determined by the method described in R. Shroff and H. Mavridis, “New Measures of Polydispersity from Rheological Data on Polymer Melts,” J. Applied Polymer Science 57 (1995) 1605 (see also U.S. Pat. No. 5,534,472 at Column 10, lines 20-30). ER was calculated from:

$$ER = ( 1.781 * {10}^{- 3} ) * {G}^{′}$$

$$at a value of {G}^{″} = 5 , 000 dyn / {cm}^{2} .$$

When the lowest G″ value was greater than 5,000 dyn/cm², the determination of ER involved extrapolation and depended on the degree on nonlinearity in the log G′ versus log G″ plot. The temperature, plate diameter and frequency range were selected such that, within the resolution of the rheometer, the lowest G″ value was close to or less than 5,000 dyn/cm².

### Comonomer Content

The comonomer content was determined by IR in accordance with ASTM D 6248 98, using an FT-IR spectrometer Tensor 27 from Bruker.

### Melt Strength

The test device measured the extensional properties of polymer melts by drawing a vertical melt strand under constant force in the Rheotens spinline, which is located underneath the capillary die, at either constant pull-off speed or with a linear accelerating velocity.

Melt Strength analysis was carried out at 190° C. on a Göttfert Rheotester 1000 (12 mm Barrel diameter, Capillary die L/D=20/2), equipped with a RHEOTENS 71.97 device. The RHEOTENS consisted of two upper and two lower driven, counter rotating wheels that were connected to a balance-system. The vertical gap between the wheels was 0.3 mm. After 10 min. melting time, the polymer was extruded with a shear rate of 50 l/s. The polymer strand left the capillary die. The die-exit velocity v₀ was recorded. At a strand length of 74 mm, the upper two wheels pulled the melt strand downwards with an acceleration of 2.4 mm/s². The velocity v was recorded (the lower two wheels were for additionally stabilizing the strand during drawdown). The drawdown ratio 1=v/v₀ at break, the velocity at break, and the force at break of the melt strand (F(max)=Melt Strength) were recorded.

### Example 1

As first component, a LDPE recyclate was used. The properties of the recyclate are reported in Table 1, where the recyclate is identified as “R1”

The commercial grade Lupolen 1800S, which was from LyondellBasell Industries, was used as second component.

Lupolen 1800S was a virgin LDPE, having the properties reported in Table 1, where the LDPE is identified as “LP 1800S”.

The low density polyethylene product of Example 1 was obtained by extruding the first and second component in an extruder.

The machine parameters were:
Rotation speed: 300 rpm;
Throughput: 30 kg/h;
Temperatures:
Zone 1: 200° C., Zone 2: 220° C., Zone 3-10: 240° C., Die: 240° C.;
SEI: 0.092 kWh/kg.

There are different ways to calculate the specific energy input SEI. In some instances, SEI is calculated by dividing the motor power with the material flow. Motor power is equal to the torque multiplied with the angular velocity. The equation for the SEI is as follows:

$$SEI = \frac{( 2 \cdot π \cdot n \cdot {M}_{D} )}{\dot{m}} .$$

Here, 2*π*n represents the angular velocity ω, M_{D} stands for the torque and m represents the material flow. In some instances, the torque of the motor is not directly measurable. Then, SEI is calculated approximately, according to the following equation and using the maximum and the actual current of the motor.

$$SEI = {P}_{max} * \frac{{n}_{actual}}{{n}_{max}} * \frac{{I}_{actual}}{{I}_{max}} * \frac{{η}_{transmission}}{\dot{m}}$$

Here, “n” represents the speed of the screws, “I” stands for the current and “ηₜᵣₐₙₛₘᵢₛₛᵢₒₙ” is the efficiency of the transmission.

The properties of the blended low density polyethylene composition are reported in Table 1, wherein the blended composition is identified as “Blend1”. The relative amounts in the blend were 50% by weight of the first component and 50% by weight of the second component, with respect to the total weight of the blended low density polyethylene composition.

As a comparison, the properties of a virgin LDPE composition are listed in Table 1, and the composition is identified therein as “LP 2420H”. The virgin LDPE composition was commercial grade Lupolen 2420H, which was used for foaming applications, blown films, or both.

TABLE 1

| | R1 | LP 1800S | Blend1 | LP 2420H |
|---|---|---|---|---|
| MIP [g/10 min] | 0.97 | 66.3 | 7.06 | 7.74 |
| MIE [g/10 min] | 0.23 | 19.1 | 1.74 | 1.93 |
| Density [g/cm³] | 0.928 | 0.917 | 0.925 | 0.922 |
| Mw [g/mol] | 195799 | 74622 | 134878 | 109464 |
| Mw/Mn | 10.6 | 7.5 | 10.5 | 7.1 |
| MIP/MIE | 4.2 | 3.5 | 4.1 | 4.0 |
| ER | 4.2 | 1.1 | 2.8 | 1.9 |
| MIE/ER | 0.06 | 17.69 | 0.615 | 1.01 |
| F(max) [N] | 0.177 | n.a. | 0.090 | 0.088 |

### Example 2 and Example 3

For Examples 2 and 3, a different LDPE recyclate was used, as compared to Example 1. The properties of the recyclate are reported in Table 2, where the recyclate is identified as “R2”

The commercial grade Lupolen 1800S, from LyondellBasell Industries, was used as second component, like in Example 1.

The low density polyethylene products of Example 2 and Example 3 were obtained by extruding the first and second component in an extruder.

The machine parameters were:
Rotation speed: 300 rpm;
Throughput: 30 kg/h;
Temperatures:
Zone 1: 200° C., Zone 2: 220° C., Zone 3-10: 240° C., Die: 240° C.;
SEI: 0.092 kWh/kg for Example 2 and 0.093 kWh/kg for Example 3.

The properties of the blended low density polyethylene composition are reported in Table 2, wherein the blended composition is identified as “Blend2” and “Blend3”, respectively. The relative amounts in the blend were 50% by weight of the first component and 50% by weight of the second component, with respect to the total weight of the blended low density polyethylene composition, for “Blend2”. The relative amounts in the blend were 60% by weight of the first component and 40% by weight of the second component, with respect to the total weight of the blended low density polyethylene composition, for “Blend3”.

TABLE 2

| | R2 | LP 1800S | Blend2 | Blend3 |
|---|---|---|---|---|
| MIP [g/10 min] | 2.84 | 66.3 | 8.83 | 6.42 |
| MIE [g/10 min] | 0.79 | 19.1 | 2.36 | 1.71 |
| Density [g/cm³] | 0.928 | 0.917 | 0.923 | 0.924 |
| Mw [g/mol] | 163257 | 74622 | 108165 | 123250 |
| Mw/Mn | 8.1 | 7.5 | 8.1 | 8.8 |
| MIP/MIE | 3.6 | 3.5 | 3.7 | 3.8 |
| ER | 2.9 | 1.1 | 2.3 | 2.5 |
| MIE/ER | 0.272 | 17.69 | 1.026 | 0.679 |
| F(max) [N] | 0.122 | n.a. | 0.072 | 0.082 |

### Example 4

For Example 4, the first component was identical to the first component of Example 2 and Example 3.

However, for the second component, the commercial grade Lupolen 2420K, from LyondellBasell Industries, was used.

Lupolen 2420K was a virgin LDPE, having the properties reported in Table 3, where the virgin LDPE is identified as “LP 2420K”.

The low density polyethylene product of Example 4 was obtained by extruding the first component and the second component in an extruder.

The machine parameters were:
Rotation speed: 300 rpm;
Throughput: 30 kg/h;
Temperatures:
Zone 1: 200° C., Zone 2: 220° C., Zone 3-10: 240° C., Die: 240° C.;
SEI: 0.081 kWh/kg.

The properties of the blended low density polyethylene composition are reported in Table 1, wherein the blended composition is identified as “Blend4”. The relative amounts in the blend were 30% by weight of the first component and 70% by weight of the second component, with respect to the total weight of the blended low density polyethylene composition.

TABLE 3

| | R2 | LP 2420K | Blend4 |
|---|---|---|---|
| MIP [g/10 min] | 2.84 | 14.37 | 6.53 |
| MIE [g/10 min] | 0.79 | 3.53 | 1.65 |
| Density [g/cm³] | 0.928 | 0.923 | 0.925 |
| Mw [g/mol] | 163257 | 97540 | 110140 |
| Mw/Mn | 8.1 | 7.8 | 7.8 |
| MIP/MIE | 3.6 | 4.1 | 4.0 |
| ER | 2.9 | 1.4 | 2.1 |
| MIE/ER | 0.272 | 2.451 | 0.771 |
| F(max) [N] | 0.122 | 0.038 | 0.084 |

Tables 1 to 3 show, that, in some embodiments, by blending LDPE recyclate material with a virgin LDPE, which are not used for foaming applications, low density polyethylene composition is produced. In some embodiments, the blended composition has similar properties as a commercial grade low density polyethylene composition for foaming applications. In some embodiments, “Blend” made from or containing about 25% by weight of LLDPE, relative to the total weight of the blended low density polyethylene composition, is useful for foaming applications. In some instances, it is believed that LLDPE is not used for such foaming applications because the LLDPE has a lower melt strength which will lead to a high pressure build up when foaming and thus to a shutdown of the set up.

In some embodiments, a foamed article was continuously produced with a throughput of 100 to 200 kg/h. In some instances and when using LP2420K or LP 1800S in the absence of other polymers, the foamability was not given, leading to tears and holes. In some instances and when using R1 or R2, a pressure buildup led to a shutdown of the extruder.

What is claimed is:

1. A process for producing a blended low density polyethylene composition, comprising the step of:
blending
from 30 to 90% by weight of a first component comprising one or more recycled polymer compositions, based upon the total weight of the low density polyethylene composition, and
from 70 to 10% by weight of a second component comprising one or more low density polyethylenes, based upon the total weight of the low density polyethylene composition,
wherein the blended low density polyethylene composition has
a) a density from 0.910 to 0.940 g/cm³, determined according to ISO 1183-1:2012 at 23° C.;
b) a ratio MIP/MIE from 1.8 to 6, where MIP is the melt flow index at 190° C. with a load of 5 kg; and MIE is the melt flow index at 190° C. with a load of 2.16 kg, both determined according to ISO 1133-2:2011;
c) MIP values from 3 to 20 g/10 min;
d) ER values from 1 to 4; and
e) a ratio MIE/ER from 0.2 to 2.8;
wherein ER is calculated from
$$ER = ( 1.781 * {10}^{- 3} ) * G ’$$
$$at a value of G ” = 0.5 kPa ( 5000 dyn / {cm}^{2} ) ;$$
$$wherein :$$
$$G ’ = storage modulus$$
$$G ” = loss modulus ;$$
both G′ and G″ being measured with dynamic oscillatory shear in a plate-plate rotational rheometer at a temperature of 190° C.

2. The process of claim 1, wherein at least one of the following additional features applies:
the MIP/MIE ratio of the first component and the blended low density polyethylene composition (MIP/MIE_{first component}:MIP/MIE_{blended LDPE composition}) is from 0.50 to 1.80;
the MIP ratio of the blended low density polyethylene composition and the first component (MIP_{blended LDPE composition}:MIP_{first component}) is from 1.5 to 15; or
the ER ratio of the first component and the blended low density polyethylene composition (ER_{first component}:ER_{blended LDPE composition}) is from 0.8 to 3.

3. The process of claim 1, wherein at least one of the following additional features applies:
the MIP/MIE ratio of the first component and the second component (MIP/MIE_{first component}:MIP/MIE_{second component}) is from 0.50 to 2.00;
the MIP ratio of the second component and the first component (MIP_{second component}:MIP_{first component}) is from 2 to 100; or
the ER ratio of the first component and the second component (ER_{first component}:ER_{second component}) is from 1.5 to 10.

4. The process of claim 1, wherein the blended low density polyethylene composition comprises between 30 to 90% by weight of a fraction of recyclate material, based upon the total weight of the blended low density polyethylene composition.

5. The process of claim 1, wherein the first and second components are melt blended in an extruder device at a temperature of from 180 to 250° C.

6. The process of claim 5, wherein the process further comprises the step of:
homogenizing the first component and the second component before or during melt blending of the components.

7. The process of claim 1, wherein the second component comprises virgin LDPE.

8. The process of claim 1, wherein the first component further comprises one or more additional polyethylene components selected from the group consisting of HDPE, MDPE, LLDPE and mixtures thereof.

9. The process of claim 1, wherein the blended low density polyethylene composition comprises from 1 to 40% by weight of LLDPE, based upon the total weight of the low density polyethylene composition.

10. The process of claim 1, wherein the blended low density polyethylene composition has at least one of the following additional features:
a MIE of 1 g/10 min or higher;
a Mw from 60000 to 180000 g/mol;
a Mw/Mn ratio from 3 to 18; or
F(max) values of 0.04 N or higher, measured with a Rheotens device at 190° C. with an acceleration of 2.4 mm/s².

11. A blended low density polyethylene composition obtainable by the process of claim 1.

12. A manufactured article comprising the blended low density polyethylene composition of claim 11.

13. The manufactured article of claim 12, wherein the manufactured article is in the form of a foamed article, a cast film or a blown film.
